(19) United States
(12) Patent Application Publication
(10) Pub. No.: US 2022/0032393 A1
(43) Pub. Date: Feb. 3, 2022

(54) FILL LEVEL DETECTION FOR ELECTRODE CAP MAGAZINES

(71) Applicant: BRAEUER SYSTEMTECHNIK GMBH, MlLDENAU (DE)

(72) Inventors: JENS NITZ, SEHMATAL (DE); FRANK SONNTAG, THUM (DE); ROBIN KUETTNER, CROTTENDORF (DE)

(21) Appl. No.: 17/276,241

(22) PCT Filed: Feb. 20, 2019
(86) PCT No.: PCT/EP2019/000053

§ 371 Date: Mar. 15, 2021

(30) Foreign Application Priority Data
Sep. 14, 2018 (DE) 10 2018 007 252.6

(51) Int. Cl. B23K 11/36; B23K 11/11; B23K 11/30

(52) U.S. Cl. CPC B23K 11/36; B23K 11/3072; B23K 11/115

(57) ABSTRACT

A fill level detection device for electrode cap magazines of welding electrodes includes at least one electrode cap channel disposed in the electrode cap magazine. At least one cap conveyor is disposed in a linearly movable manner, is preferably spring-loaded, is disposed in the electrode cap channel and moves the electrode caps contained in the electrode cap channel toward a removal opening for access by a welding gun. The electrode cap channel has a mechanically connected element which serves as a measuring surface and has an attached and/or fixed side on which a sensor for measuring a distance is disposed. The sensor projects a measuring beam onto the measuring surface to measure the distance between the sensor and the measuring surface, which enables the exact number of electrode caps contained in the electrode cap magazine to be determined by evaluating the distance measured by the sensor.

The invention relates to a fill level detection device for electrode cap magazines for welding electrodes.

Especially in the automotive industry, spot welding is often used in car body production in automated production lines to join metal sheets and strips.

Welding robots are usually used to connect the body panels via spot welding.

These welding robots are equipped with welding guns, each jaw of which is equipped with a spot welding electrode, which is referred to as an electrode cap.

These welding guns are moved to the sheet metal parts positioned to be welded together. The exact position of the welding gun with respect to metal sheets to be welded together and the arrangement of the metal sheets with respect to each other are determine automatically and with the aid of a computer.

In such an automated production line, the welding operations execute with the shortest possible cycle times and without interruption.

As a result, the electrode caps in particular are subject to high wear because the contact surfaces of the electrode caps make contact with each of the sheet metal body panels to be welded.

In this welding operation, current flows between the electrodes through the overlapping body panels to be welded together.

During this operation, a change occurs at the contact surfaces of the electrode caps at their welding areas.

Frequently, the edges of the contact surfaces flatten out, which is referred to as mushrooming, and change the welding conditions by enlarging the contact surface area.

In order to ensure this change does not have to be counteracted by increasing the current, the electrode caps are dressed regularly depending on the loads they are exposed to and the resulting wear.

In many cases, the interacting electrodes of a welding gun will wear to the same or similar extent, and accordingly need to be dressed again regularly and at the same time.

After a certain number of dressing processes, the amount of material removed from the electrode cap is so great that electrode cap needs to be replaced.

For replacement purposes, the worn electrode caps are pulled off the welding electrode shafts.

To equip the welding electrode shafts with new unused electrode caps, a simple embodiment of a magazine is usually used. These magazines are arranged in such a manner that the welding guns mount new electrode caps by closing the jaws in a defined position and define the positions of the caps on the welding electrode shaft by pressing the welding tongs against each other. Since the magazines must be arranged in a defined position to be approached by the welding gun, it is necessary to leave these magazines in position and to refill the magazines manually on site.

However, this usually requires the process to be interrupted because it is impossible due to safety regulations to perform refilling during operation since persons are not allowed to move within the range of motion of an active robot.

Exchanging the magazines has also been suggested to eliminate this disadvantage.

For example, DE 199 05 477 describes a magazine for electrode caps of welding electrodes, in particular for the welding guns of welding robots. This solution suggests placing the electrode caps to be stored in a magazine in a row in cap guides whose profiles correspond to the shape of the electrode caps, whereby the cap guides are parallel to the longitudinal axis of the magazine and have a removal opening in the same position.

In this case, the removal opening is opened far enough in the direction of access of the welding gun that one welding cap each is arranged with its opening positioned in the direction of access and is exposed for full access.

Solutions are also known, for example from DE102009058937, which have a magazine head in a fixed position to ensure the reliability of the process and in which an electrode cap changing magazine is latched.

One disadvantage of the previously known solutions is that only one filling level indicator of the electrode caps can be monitored by means of an initiator and that a completely empty electrode cap magazine cannot be detected or monitored.

According to EP2072170 “Magazine unit for a spot welding cap changer for a robotic or stationary spot welding device”, an inductive sensor is used with which metal pins can be detected, but an exact fill level cannot be measured.

DE20000270 “Fill Level indicator for one, two, and multi-row ammunition magazines” suggests using a mechanical counting mechanism.

A solution in which a signal is output when the fill level drops below a minimum fill level is suggested in DE19905477 “Device for providing electrode caps for welding electrodes of automatic welding machines”.

This solution cannot measure the exact fill level either.

In the known solutions, it is therefore impossible to individually plan the time for refilling or exchanging the electrode cap magazines

The invention is based on the task of proposing a solution with which the difficulties of previously known solutions are avoided to the greatest extent possible and enable accurate detection of the fill level of the electrode cap magazine.

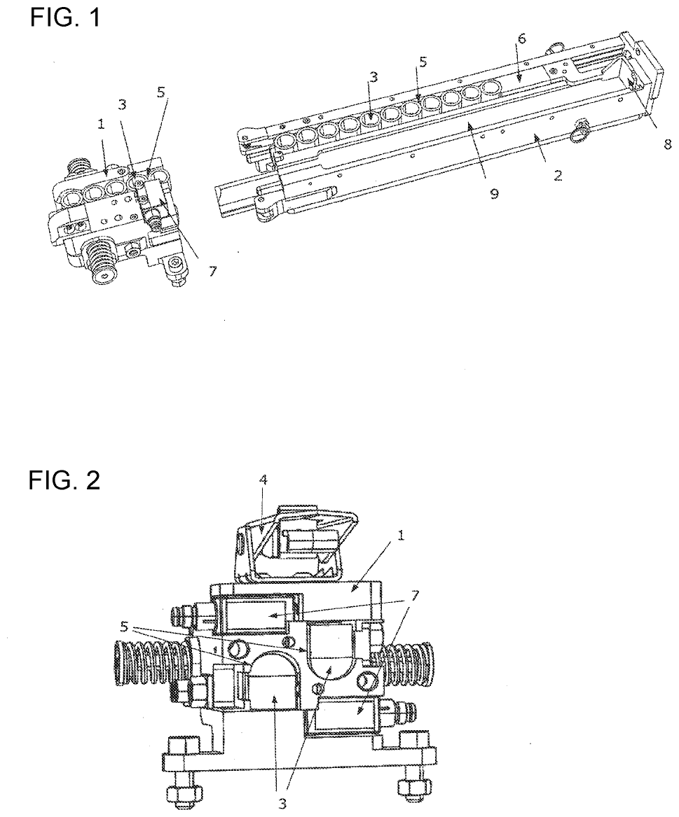

This task is achieved by a device according to claims 1 to 3, and this system will be explained in more detail in FIGS. 1 to 4 and in the following description of an embodiment.

This embodiment shows a solution to the task according to the invention using the example of an electrode cap magazine consisting of a magazine head 1 and a change magazine 2.

However, it is also possible to use the solution according to the invention in a single-piece electrode cap magazine already known from the prior art.

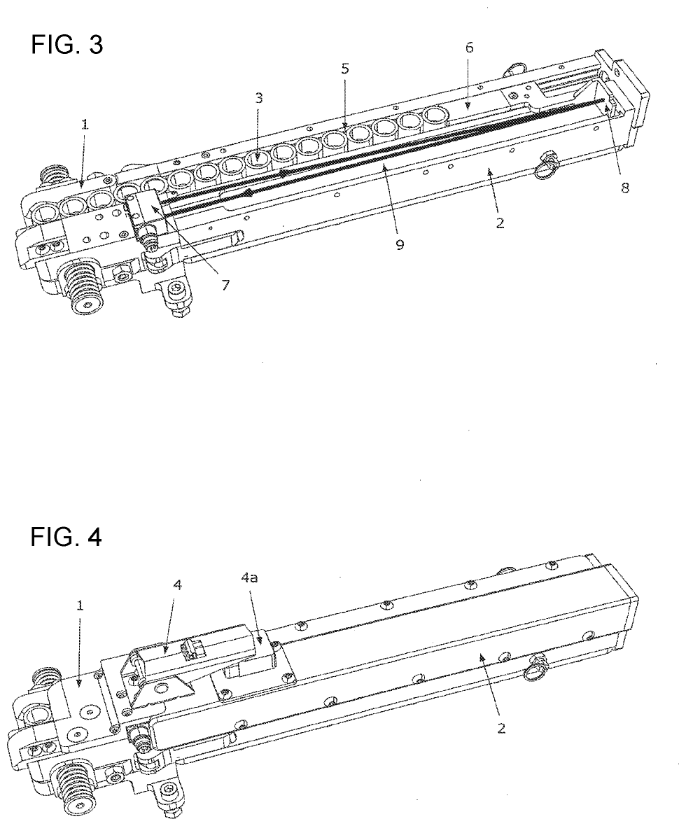

FIG. 1 shows a detailed view of the electrode cap magazine with fill level detection according to the invention in a decoupled state with a sensor 7 and measuring surface 8, FIG. 2 shows a two-channel magazine head 1 with one sensor 7 for each electrode cap channel 5, FIG. 3 shows a detailed view of the measurement beam from the sensor 7 on measuring surface 8 in an electrode cap magazine with fill level detection, and FIG. 4 shows an electrode cap magazine with fill level detection according to the invention in a coupled state.

The electrode cap magazine according to the invention consists of a magazine head 1 and an interchangeable magazine 2.

To connect the interchangeable magazine 2 to the magazine head 1, quick release devices 4 and 4a are arranged so that the tensioner 4 is arranged on magazine head 1 and the tension hook 4a is arranged on the interchangeable magazine 2. This arrangement makes sense technically since the interchangeable magazine 2 moves towards the magazine head 1 in the direction of force of the tensioner 4 to be activated, and therefore experiences a loading force in the direction of its functional position.

To ensure the magazine head 1 and the interchangeable magazine 2 are in a defined position when connecting these two assemblies, at least one guide element is arranged.

This guide element is preferably designed in terms of its shape and dimensional tolerances so that it can easily be engaged and still ensure the magazine head 1 and the interchangeable magazine 2 are in defined positions with respect to each other.

The electrode caps 3 are stored in the interchangeable magazine 2 and in the magazine head 1, whereby the interchangeable magazine 2 and the magazine head 1 according to the exemplary embodiment and the figures are equipped with two electrode cap channels 5, which are arranged parallel to the longitudinal axis of the interchangeable magazine 2 and also in the same arrangement in the magazine head 1.

The electrode cap channels 5 are mounted diagonally offset in the interchangeable magazine 2 and magazine head 1 so that the contact surfaces of the electrode caps face each other and are diagonally offset.

However, the inventive concept also includes technical designs that are only equipped with one or more electrode cap channels 5 or only with one or more cap guides.

Through this arrangement of the electrode caps 3 in the interchangeable magazine 2 and magazine head 1 with the opening of the electrode caps 3 facing outwards, it is possible for the welding gun to extend into electrode cap 3 removal openings to mount the electrode caps 3 with their electrode shafts.

If multiple electrode cap channels are used, the cross-section of interchangeable magazine 2 and magazine head 1 are arranged facing each other with a diagonal offset. This arrangement of the electrode cap channels 5 was selected to realize the smallest possible size of the unit because the overall height of the device is thus less than the height of two opposing caps plus the wall thickness of the separating wall of the cap guide.

According to the prior art, the electrode cap channels 5 are designed to transport the electrode caps 3 with little force and to prevent the caps 3 from tilting and getting jammed in the electrode cap channel 5, especially at the junction between the interchangeable magazine 2 and magazine head 1. This is achieved by designing the electrode cap channels 5 with the same shape as the electrode caps 3 plus the appropriate tolerances.

A known technical solution for precise connection of the magazine head 1 and interchangeable magazine 2 is described in DE102009058937.

In every electrode cap channel 5, there is at least one cap conveyor 6 arranged in a linearly movable manner, preferably loaded with a spring force, which moves the electrode caps 3 located in the electrode cap channel 5 towards the magazine head 1.

The position of the cap conveyor 6 in the electrode cap channel 5 depends on the number of electrode caps 3 located in the interchangeable magazine 2 and in the magazine head 1.

At least one sensor 7 is arranged in the magazine head 1 to measure distance. This sensor 7 projects a measuring beam onto at least one measuring surface 8, for example a reflective surface, in the measurement channel 9 of the interchangeable magazine 2 to measuring the distance between the sensor 7 and measuring surface 8.

A reflection light scanner, for example, can be used as a sensor 7, which shines a beam on the reflective surface acting as the measurement surface 8.

A measuring surface 8 is mechanically connected to the cap conveyor 6 so that the measurement is realized in a measuring channel 9 arranged parallel to the electrode cap channel 5 and so that there is a direct dependency between the number of electrode caps 3 in electrode cap channel 5 and the position of the measurement surface 8 in measuring channel 9.

A change in the number of electrode caps 3 in the interchangeable magazine 2 and magazine head 1 due to removal of an electrode cap changes the distance measured by the sensor 7.

By evaluating the distance measured by the sensor, the exact number of electrode caps 3 in the magazine head 1 and in the interchangeable magazine 2 can be determined.

The advantage is that it is possible to plan the time when the electrode caps 3 will be refilled individually since, according to the invention, because it is not only possible to detect when a certain fill level is reached, but also to determine the exact number of electrode caps 3.

1-3. (canceled)

4. A system for detecting an electrode cap fill level in welding electrodes, the system comprising:
an electrode cap magazine including a magazine head and an interchangeable magazine;
a quick release device for connecting said interchangeable magazine to said magazine head;
at least one guide device for ensuring a defined position of said magazine head and said interchangeable magazine upon interconnecting said interchangeable magazine and said magazine head;
said interchangeable magazine having at least one electrode cap channel;
at least one cap conveyor linearly movably disposed in said at least one electrode cap channel for moving the electrode caps contained in said at least one electrode cap channel toward a removal opening for access by a welding gun;
a mechanically connected element to be used as a measuring surface, said measuring surface having a fixed side; and
a sensor disposed on said fixed side for projecting a measuring beam onto said measuring surface to measure a distance between said sensor and said measuring surface for determining an exact number of electrode caps contained in said electrode cap magazine by evaluating said distance measured by said sensor.

5. The system for fill level detection according to claim 4, wherein said at least one cap conveyor is loaded by a spring force.

6. The system for fill level detection according to claim 4, which further comprises a measuring channel disposed parallel to said electrode cap channel, said measuring channel containing said measuring surface, said measuring surface being mechanically connected to said cap conveyor for measuring said distance in said measuring channel parallel to said electrode cap channel.

7. A method for detecting an electrode cap fill level in welding electrodes, the method comprising:
providing an electrode cap magazine including a magazine head and an interchangeable magazine having at least one electrode cap channel;
using a quick release device to connect the interchangeable magazine to the magazine head;
using at least one guide device to ensure a defined position of the magazine head and the interchangeable magazine upon interconnecting the interchangeable magazine and the magazine head;
linearly moving at least one cap conveyor in the at least one electrode cap channel for moving the electrode caps contained in the electrode cap channel toward the magazine head;
using a mechanically connected element as a measuring surface having a fixed side;
projecting a measuring beam from a sensor disposed on the fixed side onto the measuring surface and using the sensor to measure a distance between the sensor and the measuring surface; and
determining an exact number of the electrode caps contained in the electrode cap magazine by evaluating the distance measured by the sensor.

8. The method according to claim 7, which further comprises loading the at least one cap conveyor with a spring force.
